(19) United States
(12) Patent Application Publication
(10) Pub. No.: US 2024/0399424 A1
(43) Pub. Date: Dec. 5, 2024

(54) HIGH-PRESSURE CLEANING MACHINE

(71) Applicant: Shanghai Wave Rider Fluid Technology Co., Ltd., Shanghai (CN)

(72) Inventor: Fan ZHANG, Beijing (CN)

(21) Appl. No.: 18/357,745

(22) Filed: Jul. 24, 2023

(30) Foreign Application Priority Data
May 31, 2023 (CN) 2023106314389

(51) Int. Cl. B08B 3/02; B08B 13/00

(52) U.S. Cl. CPC B08B 3/028; B08B 13/00

(57) ABSTRACT

Provided is a high-pressure cleaning machine, including a high-pressure water pump, a motor, a cover body and a water inlet of cleaning machine. The high-pressure water pump includes a shell, a driving mechanism, an isolation member, at least one plunger, and at least one plunger cavity. The driving mechanism includes a main shaft and at least one eccentric member. At least one side of the main shaft is rotatably connected to the shell via a rolling bearing. The motor is configured to drive the main shaft of the high-pressure water pump to rotate, so that the eccentric member pushes the plunger to move in the plunger cavity to pressurize water or an aqueous solution. The motor is provided with a flow channel. The flow channel is configured for the water or aqueous solution entering through the water inlet of cleaning machine to flow through.

### CROSS REFERENCE TO RELATED APPLICATION

This patent application claims the benefit and priority of Chinese Patent Application No. 2023106314389, filed on May 31, 2023, the disclosure of which is incorporated by reference herein in its entirety as part of the present application.

### TECHNICAL FIELD

The present disclosure relates to the technical field of high-pressure cleaning equipment, and in particular to a high-pressure cleaning machine.

### BACKGROUND

In high-pressure cleaning machines used at present, power equipment (e.g., motors, diesel engines, or gasoline engines) is mainly used to drive reciprocating high-pressure pumps or swash-plate high-pressure pumps to produce high-pressure water, and the cleaning function is achieved by spraying out the water by means of a high-pressure water gun. The main problems of the existing high-pressure cleaning machine are as follows.

Lubricating oil needs to be replaced regularly, which makes maintenance troublesome.

The equipment is noisy, and the noise level is generally greater than 85 dB, even more than 90 dB, affecting the life and health of the people. The invention of a low-noise high-pressure cleaning machine is disclosed in both Chinese patent No. CN102327878A and Chinese patent No. CN103624021B. In accordance with these patents, air convection is required to cool the inside of the cleaning machine, and the noise problem of the high-pressure cleaning machine is mainly solved by means of sound insulation and the reduction of the vibration of cooling air flow. The noise reduction design is complicated, but cannot completely isolate the noise propagation caused by the flowing air, and thus sound insulation effect needs to be improved.

Therefore, a new solution is urgently needed to solve the above problems.

### SUMMARY

An objective of the present disclosure is to provide a high-pressure cleaning machine to solve the problem of maintenance and noise in the prior art, which is simple in structure and good in economy.

In order to achieve the above objective, the present disclosure provides the following solution.

A high-pressure cleaning machine includes a high-pressure water pump, a motor, a cover body, and a water inlet of cleaning machine. The high-pressure water pump and the motor are enclosed by the cover body. The cover body is not provided with an air flow channel communicating inside of the cover body and outside of the cover body, or the cover body is provided with air flow channels communicating the inside of the cover body and the outside of the cover body. When the cover body is provided with the air flow channels communicating the inside of the cover body and the outside of the cover body, a sum of minimum flow channel sections of the air flow channels is less than 5% of a total area of an outer surface of the cover body. The high-pressure water pump includes a shell, a driving mechanism, at least one plunger, and at least one plunger cavity corresponding to the at least one plunger. The driving mechanism includes a main shaft, and at least one eccentric member arranged on the main shaft, and a space in the shell where the at least one eccentric member is located is communicated with the water inlet of cleaning machine. The motor is configured to drive the main shaft of the high-pressure water pump to rotate, so that the at least one eccentric member pushes the at least one plunger to move in the corresponding at least one plunger cavity to pressurize water or an aqueous solution.

The motor is provided with a flow channel; the flow channel is configured for the water or the aqueous solution entering through the water inlet of cleaning machine to flow through.

Preferably, the motor includes a motor shell, and a water jacket. The water jacket is sleeved on an outer surface of the motor shell. The water jacket is sealed on both sides of the water jacket against the motor shell. A gap between the water jacket and the motor shell forms the flow channel in a middle part of the water jacket.

Preferably, the motor shell is made of an alloy material and is molded by an extrusion process.

Preferably, the water jacket is made of an engineering plastic or die-cast aluminum alloy.

Preferably, an inner surface of the cover body is provided with a sound insulation layer.

Preferably, the shell includes a first inner cavity and a second inner cavity. The space in the shell where the eccentric member is located is the first inner cavity, at least one side of the main shaft is rotatably connected to the shell via a rolling bearing, and the rolling bearing is located in the second inner cavity of the shell. The high-pressure water pump further includes an isolation member configured for sealing the water or aqueous solution in the first inner cavity and prevent the water or aqueous solution from entering the second inner cavity.

Preferably, an outer side of each of the at least one eccentric member is sleeved with a thrust member, the thrust member is able to rotate with respect to the corresponding eccentric member, and the thrust member and the corresponding eccentric member form a first sliding friction pair. The thrust member is able to roll on a contact surface where the thrust member is contacted with a corresponding one of the at least one plunger to push the corresponding one of the at least one plunger to move in the corresponding plunger cavity to pressurize the water or the aqueous solution. An outer surface of each of the at least one eccentric member and/or an inner surface of the thrust member is provided with a first anti-friction layer. The first anti-friction layer is made of a plastic.

Compared with the prior art, the present disclosure has the following technical effects:

The high-pressure cleaning machine of the present disclosure is free of regular lubricating oil replacement and makes maintenance-free possible. Because the water or aqueous solution is used to cool the driving mechanism and motor of the high-pressure water pump, the cooling capacity is significantly better than an air convection cooling mode adopted by the traditional cleaning machine. Moreover, a closed cover body is provided outside the high-pressure water pump and the motor to effectively isolate noise propagation caused by air flow, thus reducing the system noise. The high-pressure cleaning machine of the present disclosure has a simple structure and good economy, and can well solve the maintenance problem and noise problem existing in the existing high-pressure cleaning machine.

### BRIEF DESCRIPTION OF THE DRAWINGS

To describe the technical solutions in the embodiments of the present disclosure or in the prior art more clearly, the following briefly introduces the accompanying drawings required for describing the embodiments. Apparently, the accompanying drawings in the following description show merely some embodiments of the present disclosure, and those of ordinary skill in the art may still derive other drawings from these accompanying drawings without creative efforts.

FIG. 1 is a structural schematic diagram of a high-pressure cleaning machine in accordance with the present disclosure (Embodiment I);

FIG. 2 is a structural schematic diagram of a high-pressure water pump in accordance with the present disclosure;

FIG. 3 is a schematic diagram of a driving mechanism in accordance with the present disclosure;

FIG. 4 is a sectional view of FIG. 3 in an A-A direction.

FIG. 5 is a structural schematic diagram of a high-pressure cleaning machine in accordance with the present disclosure (Embodiment II);

Reference signs in the drawings: 100—high-pressure cleaning machine; 200—high-pressure water pump; 1—cover body; 2—sound insulation layer; 3—motor rear end cover; 4—motor shell; 5—O-shaped sealing ring; 6—motor front end cover; 7—water jacket; 8—water inlet of cleaning machine; 9—water inlet of water jacket; 10—motor shaft; 11—water outlet of water jacket; 12—flange; 13—main shaft; 14—rolling bearing; 15—isolation member; 16—liquid cylinder body; 17—plunger; 18—thrust member; 19—eccentric member; 20—water retaining ring; 21—drain cavity; 22—coupling; 23—shell; 24—water inlet of high-pressure water pump; 25—first baffle; 26—spring; 27—water inlet of liquid cylinder body; 28—second anti-friction layer; 29—check valve; 30—plunger cavity; 31—plunger body; 32—rebound member; 33—first anti-friction layer; 34—driving mechanism; 35—ventilation hole; 36—drain hole; 37—first inner cavity; 38—second inner cavity; 39—flow channel; 40—motor.

### DETAILED DESCRIPTION

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by those of ordinary skill in the art based on the embodiments of the present disclosure without creative efforts shall fall within the protection scope of the present disclosure.

An objective of the present disclosure is to provide a high-pressure cleaning machine to solve the problems of maintenance and noise in the prior art, which is simple in structure and economical.

To make the objectives, features and advantages of the present disclosure more apparent and understandable, the following further describes the present disclosure in detail with reference to the accompanying drawings and the specific embodiments.

### Embodiment I

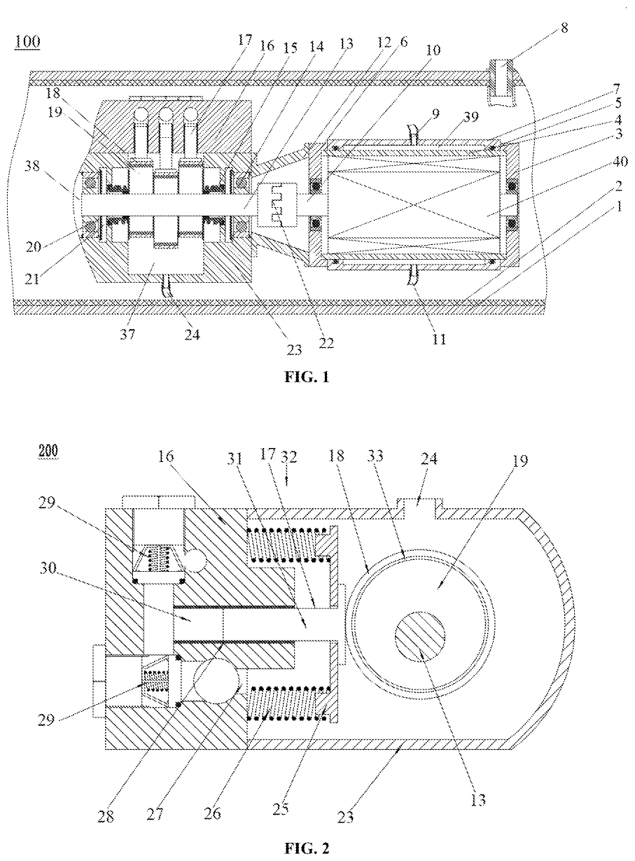

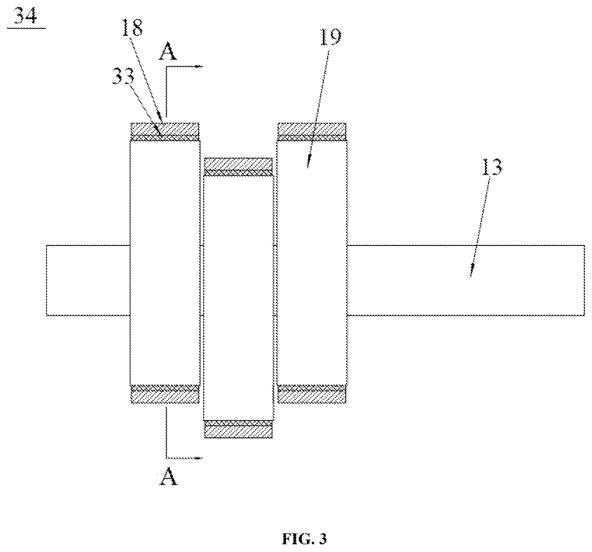

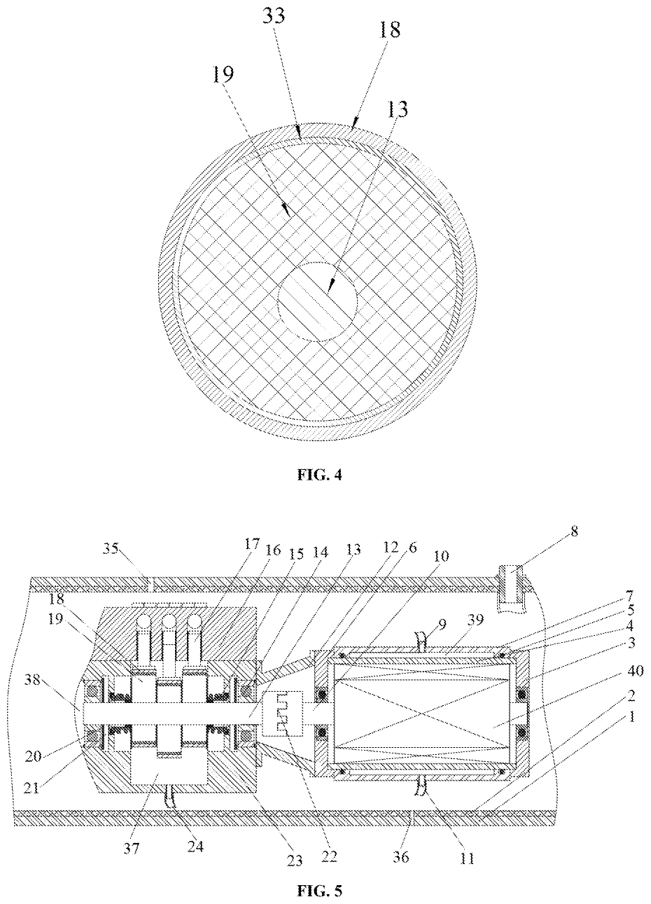

As shown in FIGS. 1-4, the present embodiment provides a high-pressure cleaning machine 100, which includes a high-pressure water pump 200, a motor 40, and a cover body 1. The cover body 1 is arranged outside of the high-pressure water pump 200 and the motor 40, and a water inlet of cleaning machine 8 and a water outlet of cleaning machine (not shown in the figure) are provided on the cover body 1.

In this embodiment, the high-pressure water pump 200 includes a liquid cylinder body 16, a shell 23, a driving mechanism 34, a rebound member 32, at least one plunger 17, and at least one plunger cavity 30. The liquid cylinder body 16 is also known as a pump head, which has the same function as a liquid cylinder body 16 of an existing reciprocating pump, and is the main part of the pump bearing hydraulic pressure. The liquid cylinder body 16 is internally provided with a high-pressure and low-pressure fluid channel and a check valve 29, and one plunger 17 corresponds to a suction valve and a discharge valve to achieve fluid distribution, so as to achieve the inflow of low-pressure water and the output of high-pressure water. The driving mechanism 34 includes a main shaft 13, and at least one eccentric member 19 arranged on the main shaft 13. In this embodiment, the eccentric member 19 is a cam, preferably in the form of an eccentric wheel. An outer side of each cam is sleeved with a thrust member 18. The thrust member 18 can rotate with respect to the cam, and the thrust member 18 and the cam form a first sliding friction pair. An outer edge profile curve of the thrust member 18 is preferably circular.

In this embodiment, both the cam and the thrust member 18 are located in a first inner cavity 37 of the shell 23, and a space in the shell 23 where the cam and the thrust member 18 are located is communicated with the water inlet of cleaning machine 8 and is configured for being filled water or an aqueous solution through the water inlet of cleaning machine 8. The water or aqueous solution can enter the first inner cavity 37 of the shell 23, so that lubrication and cooling of the first sliding friction pair can be improved by means of the water or aqueous solution. A left end of each plunger 17 is located in the liquid cylinder body 16, a right end of each plunger 17 is in contact with the thrust member 18, and the rebound member 32 is provided on the plunger 17. One end of the main shaft 13 is connected to the motor 40, and the motor 40 is configured to drive the main shaft 13 of the high-pressure water pump 200 to rotate. When the main shaft 13 drives the cam to rotate, the thrust member 18 rolls on a contact surface abutting against the plunger 17 and pushes the plunger 17 to move towards the liquid cylinder body 16 in the plunger cavity 30 of the liquid cylinder body 16, so as to pressurize the water or aqueous solution and drain the water. By means of the action of the rebound member 32, it is ensured that the plunger 17 keeps in contact with the thrust member 18 and sucks the water or aqueous solution in the return of the plunger 17.

In this embodiment, an outer surface of the cam and/or an inner surface of the thrust member 18 is provided with a first anti-friction layer 33. The first anti-friction layer 33 is made of a plastic, preferably a thermoplastic material, e.g., polyether-ether-ketone, polyphenylene sulfide, polyamide, polyarylether, etc. The tribological performance can be effectively improved by adding fibers, graphite, polytetrafluoroethylene, etc. to the plastic. The water or aqueous solution enters the first sliding friction pair to produce a fluid hydrodynamic lubrication effect.

In this embodiment, the cam and the main shaft 13 may be manufactured as an integral part or can be manufactured in separate parts and then assembled and fixed, such that the cam and the main shaft 13 can rotate synchronously. Each cam is sleeved with the thrust member 18. In this embodiment, three cams are provided on the main shaft 13, each of which is used to push one plunger 17 to pressurize the water or aqueous solution. There is a phase difference of 1200 between the three cams in a rotation direction. In a case of small displacement, one set of plunger 17/cam mechanism can be reduced, and it is possible to use only two set of plunger 17/cam mechanism. In this case, the two cams have a phase difference of 180° in the rotation directions.

In this embodiment, the plunger 17 may be a single part or include multiple parts. The plunger 17 includes a plunger body 31. One end of the plunger body 31 extends into the plunger cavity 30 of the liquid cylinder body 16, and the plunger body 31 and the plunger cavity 30 form a second friction pair. There is a gap from 1 μm to 30 μm in the second friction pair to ensure that the plunger body 31 can move smoothly in the plunger cavity 30, and to prevent a high-pressure fluid in the plunger cavity 30 from leaking to a low-pressure end. The water or aqueous solution can take away the friction heat while play a lubricating role in the friction pair in the gap.

In this embodiment, an outer surface of the plunger body 31 and/or an inner surface of the plunger cavity 30 are fixedly provided with a second anti-friction layer 28. The second anti-friction layer 28 is made of a plastic, preferably a thermoplastic material, e.g., polyether-ether-ketone, polyphenylene sulfide, polyamide, polyarylether, etc. The tribological performance can be effectively improved by adding fibers, graphite, polytetrafluoroethylene, etc. to the plastic.

In this embodiment, the rebound member 32 includes a first baffle 25, and a spring 26. The first baffle 25 is fixed to a right end of the plunger body 31. One end of the spring 26 abuts against the liquid cylinder body 16, and the other end of the spring 26 abuts against the first baffle 25.

In this embodiment, at least one side of the main shaft 13 is rotatably connected to the shell 23 by a rolling bearing 14. The rolling bearing 14 is located in a second inner cavity 38 of the shell 23 and is made of a bearing steel material and lubricated by grease. An isolation member 15 is arranged between the first inner cavity 37 and the second inner cavity 38, and the isolation member 15 may select an oil seal member, a lip seal member with a compensation function, a mechanical seal member, etc. The present embodiment preferably adopts the mechanical seal member. The isolation member 15 can prevent the water or aqueous solution from entering the second inner cavity 38.

During an operation, because the existing contact sealing member is difficult to completely seal the water or aqueous solution, a small amount of water or aqueous solution may enter the second inner cavity 38 from the first inner cavity 37 through the isolation member 15. In order to prevent the erosion of the water or aqueous solution to the rolling bearing 14, a water retaining ring 20 is fixed on a part of the main shaft 13 between the isolation member 15 and the rolling bearing 14 located, and the water retaining ring 20 is simultaneously located in a drain cavity 21, which is provided with a fluid passage extending to the outside of the shell 23. The water retaining ring 20 may further prevent the leaked water or aqueous solution from reaching the rolling bearing 14 in an axial direction, while the leaked water or aqueous solution may be drained from the drain cavity 21 to the outside of the shell 23 through the fluid passage, ensuring that the rolling bearing 14 is isolated from the water or aqueous solution.

In this embodiment, a motor shaft 10 of the motor 40 can transmit a torque the main shaft 13 through a coupling 22. The shell 23 of the high-pressure water pump 200 is connected to the motor 40 through a flange 12.

In this embodiment, the motor 40 includes a motor front end cover 6, a motor shell 4, a motor rear end cover 3, and a water jacket 7. An outer surface of the motor shell 4 is sleeved with the water jacket 7, the motor front end cover 6 and the motor rear end cover 3 are used to limit an axial displacement of the water jacket 7. In the middle part of the water jacket 7, an annular gap is formed between the water jacket 7 and the motor shell 4 so as to form a flow channel 39. The flow channel 39 is configured for the water or aqueous solution entering from the water inlet of cleaning machine 8 to flow through. O-shaped sealing rings 5 for achieving a radial sealing function are installed on contact surfaces of both sides of the water jacket 7 along the axial direction with the motor shell 4, so as to seal the flow channel 39. The motor shell 4 is made of an aluminum alloy material, which has good strength and high thermal conductivity, such that heat of the motor 40 can be rapidly transmitted to the flow channel 39 and taken away by water. As die-cast aluminum alloy has relatively weak corrosion resistance, in order to completely prevent the water or aqueous solution from entering the motor 40, the motor shell 4 is made of an aluminum alloy material formed by an extrusion process which is more corrosion-resistant than die-cast aluminum alloy, and the anti-corrosion performance of the motor shell 4 is strengthened by coating measures such as anodizing or painting. The motor front end cover 6 and the motor rear end cover 3 are relatively complex in shape, do not make contact with the water or aqueous solution, are achieved by an aluminum alloy die casting process, and are fixedly connected to the motor shell 4 by screws. As there is no load-bearing and heat dissipation requirement for the water jacket 7, in order to reduce the cost, the water jacket 7 is preferably made of an engineering plastic, and the die-cast aluminum alloy can also meet the application requirements. In this embodiment, a cooling requirement of the motor 40 can be achieved at low cost by using dissimilar materials in combination.

In this embodiment, pipelines are arranged inside the cover body 1, and the pipelines are connected from the water inlet of cleaning machine 8 to a water inlet of water jacket 9 and from a water outlet of water jacket 11 to a water inlet of high-pressure water pump 24. The water or aqueous entering from the water inlet of cleaning machine 8 of the cover body 1 first enters from the water inlet of water jacket 9 at one side of the motor 40, flows through the flow channel 39 on the motor 40, and then flows out from the water outlet of water jacket 11 on the other side of the motor 40 to enter the shell 23 through the water inlet of high-pressure water pump 24. Further, the water or aqueous solution, after achieving cooling and lubricating functions inside the shell 23 of the high-pressure water pump 200, enters the plunger cavity 30 through a water inlet of liquid cylinder body 27 and a check valve 29 to achieve pressurization, and finally flows out to a high-pressure water gun through a water outlet of cleaning machine (not shown in figure) on the cover body 1.

In order to reduce the noise of the cleaning machine to a lower level, in this embodiment, an inner surface of the cover body 1 is provided with a sound insulation layer 2, the sound insulation layer 2 is preferably, for example, porous fiber cotton.

In this embodiment, the cover body 1 isolates the high-pressure water pump 200 and the motor 40 from the outside, and during an operation, the water or aqueous solution can take away the heat generated by the high-pressure water pump 200 and the motor 40, there is no need for good air convection heat dissipation conditions required by the traditional high-pressure cleaning machine 100, and the motor 40 may no longer be provided with a fan. In addition to the necessary channel holes such as the water inlet of cleaning machine 8, a water outlet of cleaning machine, a cable channel hole and the like on the cover body, the cover body 1 can basically isolate air inside the cover body 1 from entering the external environment, and thus significantly reduce the noise propagation by air. As the ability to isolate the air inside and outside of the cover body 1 largely determines the noise of the high-pressure cleaning machine 100, it is necessary to avoid air flow channels communicating inside and outside of the cover body 1 as much as possible in design, such as further sealing the water inlet of cleaning machine 8, the water outlet of cleaning machine, and the cable channel hole. If it is unavoidable to provide air flow channels communicating the inside and outside of the cover body 1 on the cover body 1 (including the inside and outside air flow channels caused by the water inlet of cleaning machine 8, the water outlet of cleaning machine, the cable channel, etc., which are not well sealed), the sum of the minimum flow channel sections of the air flow channels communicating the inside and outside of the cover body 1 should be less than 5% of the total area of an outer surface of the cover body 1. In this embodiment, the high-pressure cleaning machine 100 is simple in structure, free of lubricating oil and maintenance, can significantly reduce noise compared with traditional equipment, and can achieve a pressure output exceeding 30 MPa.

### Embodiment II

As shown in FIG. 5, the difference between this embodiment and Embodiment I is that this embodiment shows that some holes with smaller size are formed in the cover body 1. The possible functions of these holes are as follows.

(1) Ventilation holes 35 configured for ventilating, so as to achieve the consistency of the pressure difference of inside and outside of the cover body 1.

(2) The drain holes 36 configured for draining water, so as to eliminate trace leakage caused by rotary sealing of the water pump.

This embodiment has all the advantages of the high-pressure cleaning machine 100 provided in Embodiment I and will not be described in detail here.

Several examples are used for illustration of the principles and implementation methods of the present disclosure. The description of the embodiments is merely used to help illustrate the method and its core principles of the present disclosure. In addition, those of ordinary skill in the art can make various modifications in terms of specific embodiments and scope of application in accordance with the teachings of the present disclosure. In conclusion, the content of this specification shall not be construed as a limitation to the present disclosure.

What is claimed is:

1. A high-pressure cleaning machine, comprising:
a high-pressure water pump, a motor, a cover body, and a water inlet of cleaning machine,
wherein the high-pressure water pump and the motor are enclosed by the cover body; the cover body is not provided with an air flow channel communicating inside of the cover body and outside of the cover body, or the cover body is provided with air flow channels communicating the inside of the cover body and the outside of the cover body; when the cover body is provided with the air flow channels communicating the inside of the cover body and the outside of the cover body, a sum of minimum flow channel sections of the air flow channels is less than 5% of a total area of an outer surface of the cover body;
the high-pressure water pump comprises a shell, a driving mechanism, at least one plunger, and at least one plunger cavity corresponding to the at least one plunger; the driving mechanism comprises a main shaft, and at least one eccentric member arranged on the main shaft, and a space in the shell where the at least one eccentric member is located is communicated with the water inlet of cleaning machine;
the motor is configured to drive the main shaft of the high-pressure water pump to rotate, so that the at least one eccentric member pushes the at least one plunger to move in the corresponding at least one plunger cavity to pressurize water or an aqueous solution; and
the motor is provided with a flow channel; the flow channel is configured for the water or the aqueous solution entering through the water inlet of cleaning machine to flow through.

2. The high-pressure cleaning machine according to claim 1, wherein the motor comprises a motor shell and a water jacket, and the water jacket is sleeved on an outer surface of the motor shell; the water jacket is sealed on both sides of the water jacket against the motor shell; and a gap between the water jacket and the motor shell forms the flow channel in a middle part of the water jacket.

3. The high-pressure cleaning machine according to claim 2, wherein the motor shell is made of an alloy material and is molded by an extrusion process.

4. The high-pressure cleaning machine according to claim 2, wherein the water jacket is made of an engineering plastic or die-cast aluminum alloy.

5. The high-pressure cleaning machine according to claim 1, wherein an inner surface of the cover body is provided with a sound insulation layer.

6. The high-pressure cleaning machine according to claim 1, wherein the shell comprises a first inner cavity and a second inner cavity, the space in the shell where the at least one eccentric member is located is the first inner cavity, at least one side of the main shaft is rotatably connected to the shell via a rolling bearing, and the rolling bearing is located in the second inner cavity of the shell; the high-pressure water pump further comprises an isolation member configured for sealing the water or the aqueous solution in the first inner cavity and prevent the water or the aqueous solution from entering the second inner cavity.

7. The high-pressure cleaning machine according to claim 1, wherein an outer side of each of the at least one eccentric member is sleeved with a thrust member, the thrust member is able to rotate with respect to the corresponding eccentric member, and the thrust member and the corresponding eccentric member form a first sliding friction pair; the thrust member is able to roll on a contact surface where the thrust member is contacted with a corresponding one of the at least one plunger to push the corresponding one of the at least one plunger to move in the corresponding plunger cavity to pressurize the water or the aqueous solution; an outer surface of each of the at least one eccentric member and/or an inner surface of the thrust member is provided with a first anti-friction layer; and the first anti-friction layer is made of a plastic.
